(19) United States
(12) Patent Application Publication
(10) Pub. No.: US 2015/0204805 A1
(43) Pub. Date: Jul. 23, 2015

(54) ELECTROCHEMICAL DEPOSITION AND X-RAY FLUORESCENCE SPECTROSCOPY

(71) Applicant: Element Six Technologies Limited, Oxfordshire (GB)

(72) Inventors: Mark Edward Newton, Warwickshire (GB); Julie Victoria MacPherson, Warwickshire (GB); Timothy Peter Mollart, Berkshire (GB)

(21) Appl. No.: 14/420,753

(22) PCT Filed: Aug. 9, 2013
(86) PCT No.: PCT/EP2013/066756

§ 371 Date: Feb. 10, 2015

Related U.S. Application Data
(60) Provisional application No. 61/682,849, filed on Aug. 14, 2012.

(30) Foreign Application Priority Data
Aug. 14, 2012 (GB) 1214448.1

(51) Int. Cl. G01N 23/223; G01N 23/22; G01N 27/27

(52) U.S. Cl. CPC G01N 23/223; G01N 27/27; G01N 23/2204

(57) ABSTRACT

[symbol]

an x-ray fluorescence spectrometer (52); and a sample holder (2) for the x-ray fluorescence (XRF) spectrometer (52), wherein the sample holder (2) comprises: an electrically conductive synthetic diamond electrode (4) providing a front surface (6) on which chemical species can be electro-deposited from a solution (48) comprising the chemical species; an ohmic contact (8) disposed on a rear surface of the electrically conductive synthetic diamond electrode (4); and an electrical connector (10) which is connected to the ohmic contact (8), and wherein the x-ray fluorescence spectrometer (52) comprises: an XRF sample stage (58) configured to receive the sample holder (2); an x-ray source (54) configured to apply an x-ray excitation beam to the chemical species electro-deposited on the electrically conductive synthetic diamond electrode (4) when the sample holder (2) is mounted to the XRF sample stage (58); an x-ray detector (60) configured to receive x-rays emitted from the chemical species electro-deposited on the front surface (6) of the electrically conductive synthetic diamond material when the sample holder (2) is mounted to the XRF sample stage (58); and a processor (62) configured to generate x-ray fluorescence spectroscopic data based on the x-rays received by the x-ray detector. Such system allows to carry out simultaneously and in-situ stripping voltammetry measurements together with X-ray fluorescence measurements.

### FIELD OF INVENTION

Certain embodiments of the present invention relate to the analysis of chemical species in solution using a combined electrochemical deposition and x-ray fluorescence spectroscopy technique and particularly using synthetic electrically conductive diamond electrodes in such a technique. Certain embodiments are configured to also utilize electrochemical stripping voltammetry in combination with x-ray fluorescence spectroscopy.

### BACKGROUND OF INVENTION

Electrochemical sensors are well known. It has also been proposed in the prior art to provide a diamond based electrochemical sensor. Diamond can be doped with boron to form semi-conductive or metallic conductive material for use as an electrode. Diamond is also hard, inert, and has a very wide potential window making it a very desirable material for use as a sensing electrode for an electrochemical cell, particularly in harsh chemical, physical, and/or thermal environments which would degrade standard metal based electrochemical sensors. In addition, it is known that the surface of a boron doped diamond electrode may be functionalized to sense certain species in a solution adjacent the electrode.

One problem with using diamond in such applications is that diamond material is inherently difficult to manufacture and form into suitable geometries for sophisticated electrochemical analysis. To date, diamond electrodes utilized as sensing electrodes in an electrochemical cell have tended to be reasonably simple in construction and mostly comprise the use of a single piece of boron doped diamond configured to sense one physical parameter or chemical species at any one time. More complex arrangements have involved introducing one or more channels into a piece of boron doped diamond through which a solution can flow for performing electrochemical analysis. However, due to the inherent difficulties involved in manufacturing and forming diamond into multi-structural components, even apparently relatively simple target structures can represent a significant technical challenge.

In terms of prior art arrangements, WO 2005012894 describes a microelectrode comprising a diamond layer formed from electrically non-conducting diamond and containing one or more pin-like projections of electrically conducting diamond extending at least partially through the layer of non-conducting diamond and presenting areas of electrically conducting diamond at a front sensing surface. In contrast, WO2007107844 describes a microelectrode array comprising a body of diamond material including alternating layers of electrically conducting and electrically non-conducting diamond material and passages extending through the body of diamond material. In use, fluid flows through the passages and the electrically conducting layers present ring-shaped electrode surfaces within the passages in the body of diamond material.

More recently, it has been proposed that high aspect ratio boron doped diamond electrodes have improved sensing capability when compared with other boron doped diamond electrode arrangements. That is, it has been found to be highly advantageous to provide boron doped diamond electrodes which have a high length/width ratio at a sensing surface. Furthermore, it has been found that an array of high aspect ratio boron doped diamond electrodes providing a band sensor structure can be utilized to provide multiple sensing functions.

The previously described arrangements may comprise optically opaque, electrically conductive boron doped diamond electrodes spaced apart by optically transparent, non-conductive intrinsic diamond layers. The optically opaque, electrically conductive boron doped diamond electrodes can be driven to perform electrochemical measurements of species in aqueous solution. It has also been suggested that electrochemical techniques can also be combined with optical techniques such as spectroscopic measurements by using the non-conductive intrinsic diamond layers as an optical window as described in WO2007/107844. As such, electrochemical measurements can be performed at the optically opaque, electrically conductive boron doped diamond electrodes and optical measurements of the solution can be performed through non-conductive intrinsic diamond layers.

Swain et al. describe a combined electrochemistry-transmission spectroscopy technique for analysing chemical species in solution. The technique uses an electrochemical cell comprising an optically transparent carbon electrode (e.g. a thin film of boron-doped diamond on an optically transparent substrate), a thin solution layer, and an optical window mounted opposite the optically transparent carbon electrode such that transmission spectroscopy can be performed on species within the solution. The optically transparent carbon electrode is used to oxidize and reduce species in the solution. In situ IR and UV-visible spectroscopy is performed through the optically transparent carbon electrode to analyse dissolved species in the solution. Dissolved species which have different IR and UV-visible spectra in different oxidation states can be analysed. Although boron-doped diamond material is opaque at high boron concentrations, at least in the near infrared, visible, and UV regions of the electromagnetic spectrum due to a high absorption coefficient in these regions, thin films of such material have a reasonable optical transparency. It is described that the ability to cross-correlate electrochemical and optical data may provide new insights into the mechanistic aspects of a wide variety of electrochemical phenomena including structure-function relationships of redox-active proteins and enzymes, studies of molecular absorption processes, and as a dual signal transduction method for chemical and biological sensing [see “Measurements: Optically Transparent Carbon Electrodes” Analytical Chemistry, 15-22, 1 January 2008, “Optically Transparent Diamond Electrode for Use in IR Transmission Spectroelectrochemical Measurements” Analytical Chemistry, vol. 79, no. 19, Oct. 1, 2007, “Spectroelectrochemical responsiveness of a freestanding, boron-doped diamond, optically transparent electrode towards ferrocene” Analytica Chimica Acta 500, 137-144 (2003), and “Optical and Electrochemical Properties of Optically Transparent, Boron-Doped Diamond Thin Films Deposited on Quartz” Analytical Chemistry, vol. 74, no. 23, 1 December 2002]. Zhang et al. have also reported the use of an optically transparent boron-doped diamond thin film electrode for performing combined electrochemistry-transmission spectroscopy analysis [see “A novel boron-doped diamond-ciated platinum mesh electrode for spectroelectrochemistry” Journal of Electroanalytical Chemistry 603. 135-141 (2007)].

As an alternative to analysing chemical species while in solution as described above, one useful electro-chemical analysis technique involves applying a suitable voltage to a sensing electrode to electro-deposit chemical species out of solution onto the sensing electrode and then change the voltage to strip the species from the electrode. Different species strip from the electrode at different voltages. Measurement of electric current during stripping generates a series of peaks associated with different species stripping from the sensing electrode at different voltages. Such a stripping voltammetry technique can be used to analyse heavy metal content.

The use of a boron-doped diamond sensor in a stripping voltammetry technique has been described in US7883617B2 (University of Keio). Jones and Compton also describe the use of a boron-doped diamond sensor in stripping voltammetry techniques [see “Stripping Analysis using Boron-Doped Diamond Electrodes” Current Analytical Chemistry, 4, 170-176 (2008)]. This paper includes a review which covers work on a wide range of analytical applications including trace toxic metal measurement and enhancement techniques for stripping voltammetry at boron-doped diamond electrodes including the use of ultrasound energy, microwave radiation, lasers and microelectrode arrays. In the described applications a boron-doped diamond material is used for the working/sensing electrode in combination with standard counter and reference electrodes.

McGraw and Swain also describe using stripping voltammetry to analysis metal ions in solution using an electrochemical cell comprising a boron-doped diamond working electrode in combination with standard counter and reference electrodes (a carbon rod counter electrode and a silver/silver chloride reference electrode). It is concluded that boron-doped diamond is a viable alternative to Hg for the anodic stripping voltammetry determination of common metal ion contaminants [see “A comparison of boron-doped diamond thin-film and Hg-coated glassy carbon electrodes for anodic stripping voltammetric determination of heavy metal ions in aqueous media” Analytica Chimica Acta 575, 180-189 (2006)].

In addition to the stripping voltammetry techniques described above, it is also known to use spectroscopic techniques for analysing electro-deposited films. For example, Peeters et al describe the use of cyclic voltammetry to electrochemically deposit cobalt and copper species onto a gold electrode using a three electrode cell comprising a saturated calomel reference electrode, a carbon counter electrode, and a gold working electrode. The gold electrodes comprising electrochemically deposited cobalt and copper species were subsequently transferred to a synchrotron radiation X-ray fluorescence (SR-XRF) facility for SR-XRF analysis to determine the heterogeneity of the deposited layers and the concentrations of Co and Cu. A comparison of SR-XRF results with electrochemical data was used to investigate the mechanism of thin film growth of the cobalt and copper containing species [see “Quantitative synchrotron micro-XRF study of CoTSPc and CuTSPc thin-films deposited on gold by cyclic voltammetry” Journal of Analytical Atomic Spectrometry, 22, 493-501 (2007)].

Ritschel et al. describe electrodeposition of heavy metal species onto a niobium cathode. The niobium cathode comprising the electrodeposited heavy metal species is then transferred to a total reflection X-ray fluorescence (TXRF) spectrometer for TXRF analysis [see “An electrochemical enrichment procedure for the determination of heavy metals by total-reflection X-ray fluorescence spectroscopy” Spectrochimica Acta Part B, 54, 1449-1454 (1999)].

Alov et al. describe electrodeposition of heavy metal species onto a glass-ceramic carbon working electrode. A standard silver chloride reference electrode and a platinum counter electrode were used in the electrochemical cell. The glass-ceramic carbon working electrode comprising the electrodeposited heavy metal species is then transferred to a total reflection X-ray fluorescence (TXRF) spectrometer for TXRF analysis [see “Total-reflection X-ray fluorescence study of electrochemical deposition of metals on a glass-ceramic carbon electrode surface” Spectrochimica Acta Part B, 56, 2117-2126 (2001) and “Formation of binary and ternary metal deposits on glass-ceramic carbon electrode surfaces: electron-probe X-ray microanalysis, total-reflection X-ray fluorescence analysis, X-ray photoelectron spectroscopy and scanning electron microscopy study” Spectrochimica Acta Part B, 58, 735-740 (2003)].

WO 97/15820 discloses a combined surface plasmon resonance sensor and chemical electrode sensor. The electrode comprises a very thin layer of conducting or semi-conducting material which is suitable for supporting surface plasmon resonance. Materials suitable for supporting surface plasmon resonance are indicated to be reflective metals such as gold and silver although it is indicated that if these materials form a layer of 1000 angstroms or more then they will not support surface plasmon resonance. The electrode is used to electrochemically deposit species which are then stripped to generate stripping voltammetry data. The surface plasmon resonance analysis comprises reflecting a light beam off the electrode. The optical signal is used to determine an effective index of refraction and is a function of the index of refraction of materials deposited on the electrode and the thickness of the layer of material deposited on the electrode. While the surface plasmon resonance technique cannot on its own identify unknown types of chemical species it can be used in conjunction with electrochemical data to aid identification of unknown chemical species in a solution of interest. Furthermore, if the chemical species in a solution of interest are known, then the surface plasmon resonance technique can be used to determine the amount of material deposited and determine if material is left on the metallic electrode after electrochemical stripping.

The present inventors have identified a number of potential problems with the aforementioned techniques. For example, while Swain et al. and Zhang et al. have described the use of in-situ spectroscopic techniques through a transparent electrode in an electrochemical sensor to generate spectroscopic data which is complimentary to voltammetry data, the transmission IR and UV-visible spectroscopy techniques described therein are only suitable for analysis of chemical species in solution. They are not suitable for analysing species such as heavy metals electro-deposited on an electrode. Furthermore, as the species are not concentrated by electro-deposition onto an electrode surface then low concentrations of species in solution may be below the detection limit for certain spectroscopic techniques. Further still, such spectroscopic techniques only give information about chemical species in the bulk solution and do not give information about the surface of the sensor to establish, for example, when the surface of an electrode is clean or when minerals or amalgams form on an electrode surface.

In contrast, prior art stripping voltammetry techniques on diamond electrodes are advantageous for analysing species such as heavy metals which can be electro-deposited from solution as described by Jones, Compton, McGraw and Swain. However, species discrimination in multi-metal solutions can be a problem using such techniques since the peak positions can be overlapping in stripping voltammetry data. Furthermore, stripping peak positions can also depend on the type and relative concentration of metals present in the solution and the pH of the solution. For example, the presence of a plurality of metal species can affect how the metals co-deposit and strip from the electrode. Further still, the use of standard reference and counter electrodes in such arrangements means that the electrochemical sensor is not robust to harsh chemical and physical environments, even if the diamond sensing electrode is robust to such conditions.

The problem of overlapping peaks in stripping voltammetry data can potentially be solved by applying the teachings of Peeters et al, Ritschel et al., and Alov et al. These groups have suggested electro-depositing films onto gold, niobium or glass-ceramic carbon working electrodes and then extracting the electrodes from the electro-deposition apparatus and transferring the coated electrodes to a suitable device for further analysis including, for example, electron-probe X-ray microanalysis, total-reflection X-ray fluorescence analysis, X-ray photoelectron spectroscopy and scanning electron microscopy. However, the electrodes, particularly gold, can interfere with x-ray analysis techniques such as X-ray fluorescence analysis. Furthermore, electrodes such as gold electrodes do not give particularly good electrodeposition and stripping performance. Further still, the described electro-deposition apparatus uses electrodes which are not robust to harsh chemical and physical environments.

Similar comments apply having regard to WO97/15820 which discloses that very thin metal electrodes, particularly gold, are required for supporting surface plasmon resonance in combination with stripping voltammetry. Such electrodes can interfere with spectroscopic methods suitable for identifying unknown chemical species and the described surface plasmon resonance technique is not, in itself, able to uniquely identify unknown chemical species without also combining the optical data with suitably referenced electrochemical voltammetry data. Furthermore, the thin metal electrodes required for supporting surface plasmon resonance are not robust to harsh chemical and physical environments.

It is an aim of certain embodiments of the present invention to address one or more of the aforementioned problems. In particular, certain embodiments of the present invention provide a system and method for monitoring low concentrations of a plurality of chemical species in complex chemical environments.

### SUMMARY OF INVENTION

According to a first aspect of the present invention there is provided a system comprising:
an x-ray fluorescence spectrometer; and
a sample holder for the x-ray fluorescence (XRF) spectrometer, wherein the sample holder comprises:
an electrically conductive synthetic diamond electrode providing a front surface on which chemical species can be electro-deposited from a solution comprising the chemical species;
an ohmic contact disposed on a rear surface of the electrically conductive synthetic diamond electrode; and
an electrical connector which is connected to the ohmic contact, and wherein the x-ray fluorescence spectrometer comprises:
an XRF sample stage configured to receive the sample holder;
an x-ray source configured to apply an x-ray excitation beam to the chemical species electro-deposited on the electrically conductive synthetic diamond electrode when the sample holder is mounted to the XRF sample stage;
an x-ray detector configured to receive x-rays emitted from the chemical species electro-deposited on the front surface of the electrically conductive synthetic diamond material when the sample holder is mounted to the XRF sample stage; and
a processor configured to generate x-ray fluorescence spectroscopic data based on the x-rays received by the x-ray detector.

Optionally, the system further comprises an electro-deposition apparatus, the electro-deposition apparatus comprising:
an electro-deposition sample stage configured to receive the sample holder;
an electrical controller having an electrical connector configured to connect to the electrical connector of the sample holder,
wherein the electrical controller is configured to electro-deposit the chemical species onto the front surface of the electrically conductive synthetic diamond electrode when the sample holder is mounted to the electro-deposition sample stage, electrically connected to the electrical controller, and exposed to the solution comprising the chemical species.

According to a second aspect of the present invention there is provided an analysis method using the system as defined above, the analysis method comprising:
mounting the sample holder in the electro-deposition apparatus;
electro-depositing chemical species from a solution onto the sample holder;
transferring the sample holder to the x-ray fluorescence spectrometer; and
analysing the chemical species electro-deposited on the sample holder using the x-ray fluorescence spectrometer.

Optionally, the analysis method further comprises:
transferring the sample holder back into the electro-deposition apparatus;
stripping the chemical species from the sample holder; and
measuring an electric current or charge during stripping of the chemical species thereby generating voltammetry data for the chemical species.

### BRIEF DESCRIPTION OF THE DRAWINGS

For a better understanding of the present invention and to show how the same may be carried into effect, embodiments of the present invention will now be described by way of example only with reference to the accompanying drawings, in which:

FIGS. 1(a) and 1(b) show side cross-section and front plan view diagrams respectively of a sample holder according to an embodiment of the invention;

FIGS. 2(a) and 2(b) show side cross-section and front plan view diagrams respectively of another sample holder according to an embodiment of the invention;

FIG. 3 shows a side cross-section view diagram of another sample holder according to an embodiment of the invention;

FIG. 4 shows an electro-deposition apparatus comprising the sample holder shown in FIGS. 1(a) and 1(b);

FIG. 5 shows an x-ray fluorescence spectrometer comprising the sample holder shown in FIGS. 2(a) and 2(b);

FIGS. 6(a) to 6(c) illustrate the type of data generated using embodiments of the present invention; and

FIGS. 7(a) and 7(b) illustrate another example of the type of data generated using embodiments of the present invention.

### DETAILED DESCRIPTION OF CERTAIN EMBODIMENTS

The present inventors have recently proposed a combined electro-deposition and x-ray fluorescence (XRF) analysis technique using electrically conductive diamond electrodes (PCT/EP2012/058761). The technique involves electro-depositing chemical species onto an electrically conductive diamond electrode and then using x-ray fluorescence spectroscopy to analyse the chemical species deposited on the electrically conductive diamond electrode. In one arrangement the electrochemical deposition step and the spectroscopic analysis step can be performed in two separate apparatus, an electrochemical deposition apparatus and a separate x-ray fluorescence spectrometer. In such a two stage “ex-situ” process, electrochemical deposition on the electrically conductive diamond electrode can be performed in the electrochemical deposition apparatus. The electrically conductive diamond electrode including the electrodeposited species can then be transferred to a spectrometer for XRF spectroscopic analysis. After XRF spectroscopic analysis, the electrode including the electrodeposited species can be transferred back to the electrochemical deposition apparatus to strip the electro-deposited chemical species from the electrode.

While a two stage electrochemical deposition and spectroscopic method is envisaged as a possibility in PCT/EP2012/058761, for many applications it is preferable, and in some cases essential, that the spectroscopic analysis is performed in situ within the electrochemical deposition apparatus. PCT/EP2012/058761 also envisages this possibility and suggests that an electrically conductive diamond electrode is advantageous in such an arrangement because the material is transparent to x-rays and thus the x-ray analysis can be performed through the back of the electrically conductive diamond electrode. Such a “through-electrode” configuration is considered advantageous for in-situ arrangements as otherwise the x-ray analysis must be performed through the solution being analysed which can lead to loss of sensitivity due to absorption and scattering of both the incident x-ray analysis beam and x-rays emitted from the material deposited on the electrode. Furthermore, in certain applications it is difficult to configure a system such that the x-ray analysis is performed through the solution of interest, e.g. where it is difficult to configure the system such that the solution flows between the electrode and an x-ray source and detector. As such, for these applications it is considered advantageous, or in some cases essential, for the x-ray analysis to be performed through the electrode on which the chemical species are deposited.

Despite the above, for many applications a more simple ex-situ approach will be acceptable and has the advantage that current x-ray fluorescent spectrometers will not need to be significantly modified to work in a more complex in-situ mode. An ex-situ electro-deposition approach also has the advantage that the electrically conductive diamond electrode can be loaded into the x-ray fluorescence spectrometer with the electro-deposited species facing the x-ray analysis beam without any overlying solution causing interference with the x-ray analysis technique. Such a “front-face” x-ray analysis configuration also avoids problems in reconfiguring the apparatus to perform in a through-electrode configuration which itself requires careful design to avoid x-ray attenuation and interference from device components such as ohmic contacts on the rear side of the electrodes.

Certain embodiments of the present invention are thus concerned with the more simple approach which does not utilize through-electrode x-ray analysis. As described previously in the background section of this specification, Ritschel et al. and Alov et al. have previously proposed such an approach using electro-deposition electrodes fabricated from niobium and glass-ceramic carbon respectively. One might intuitively consider that while the choice of an x-ray transparent material such as diamond is important for through-electrode x-ray analysis configurations, such a material is not required for arrangements in which the x-ray analysis is performed directly on the front face of the material deposited on the electrode. However, the present inventors consider that even using a front-face x-ray analysis configuration the use of an electrically conductive synthetic diamond electrode material is advantageous when compared to other materials. For example, in a combined electrochemical deposition and spectroscopic analysis technique it has been found that the use of a conductive diamond electrode has two main advantages over other electrode materials:
(i) In the electrochemical deposition step it has been found that conductive diamond material outperforms other electrode materials in several respects:
   a. it has a broader potential window and can be driven at high voltages allowing electrochemical deposition of a wider range of chemical species at lower concentrations;
   b. it is inert and can thus be used in harsh physical and chemical environments which would damage other electrode materials;
   c. it can be more readily cleaned and re-used.
(ii) In the spectroscopic analysis step, even if a front face x-ray analysis configuration is utilized the underlying electrode material can still interfere with the spectroscopic analysis, particularly when the layer of material electro-deposited thereon is thin. This is a particular problem for analysing species which have a very low concentration in solution where only a very thin layer of material is electro-deposited onto the electrode. X-rays can pass through such a thin layer and impinge on the underlying electrode material. If the underlying electrode material is made of a material which produces an x-ray fluorescence signal then the detected signal will be contaminated with emission from the electrode material. Since embodiments of the present invention are particularly concerned with increasing the sensitivity of x-ray fluorescence analysis techniques for chemical species present at low concentration in solution then this is particularly problematic.

The use of a diamond electrode material is also advantageous as it does not form a mercury amalgam and thus enables mercury detection. A diamond electrode material is also advantageous in that a very high electrode potential can be applied to alter pH via proton or hydroxide generation. For metal ions which are complexed in solution, digests are normally performed to free them so they are available for subsequent reduction. One way to do this is to generate very strong acid (or base) conditions electrochemically. This is also useful for cleaning the electrode. While high electrode potentials can also be applied to metal electrodes to alter pH, diamond surfaces are far more stable to this process. As such, embodiments which utilize diamond electrodes have particular relevance to oil and gas operations when robust remotely operated sensors are needed, and environmental monitoring where mercury sensitivity, long term stability, and autonomous calibration is highly advantageous.

In an ex-situ method the electro-deposition and x-ray fluorescence steps are performed in separate apparatus. As such, it is envisaged that a system will be provided comprising an electro-deposition apparatus, an x-ray fluorescence spectrometer, and a sample holder. Each of these components can be configured such that the individual components are compatible with each other. For example, the sample holder and the sample stages in each apparatus can be configured such that the sample holder can be readily mounted in either apparatus and can be readily transferred between the apparatus. While it is envisaged that a system comprising both an x-ray fluorescence spectrometer and an electro-deposition apparatus may be provided, it is also envisaged that a system may be provided with only an x-ray fluorescence spectrometer and an associated sample holder. In this case, electro-deposition may be achieved using a standard electro-deposition apparatus already available on the market or a suitable modified version thereof.

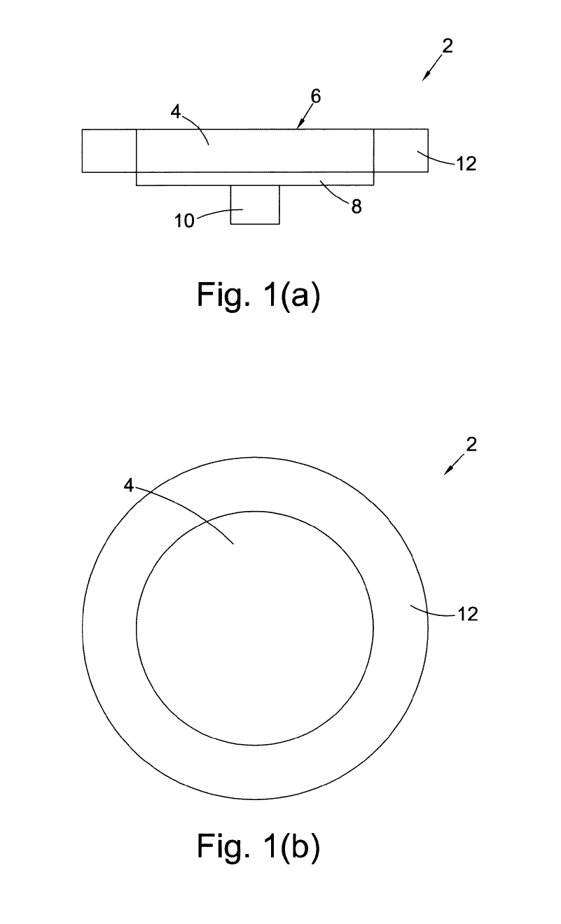

FIGS. 1(a) and 1(b) show side cross-section and front plan view diagrams respectively of a sample holder according to an embodiment of the invention. The sample holder 2 comprises: an electrically conductive synthetic diamond electrode 4 providing a front surface 6 on which chemical species can be electro-deposited from a solution comprising the chemical species; an ohmic contact 8 disposed on a rear surface of the electrically conductive synthetic diamond electrode; and an electrical contact 10 connected to the ohmic contact. The sample holder 2 also optionally comprises an electrically insulating mounting 12 around a peripheral region of the sample holder. This may be in the form of a polymeric or ceramic ring in which the electrically conductive synthetic diamond material is mounted.

Such a sample holder can be readily handled such that the sample holder can be mounted in an electro-deposition apparatus, electrically connected via the electrical connector 10, and exposed to a solution such that chemical species can be electro-deposited. The sample holder can then be removed from the electro-deposition apparatus and transferred to an x-ray fluorescence spectrometer for XRF analysis. The sample holder configuration is robust, has a long lifetime, and can readily be re-used. Furthermore, because the ohmic contact and electrical connector are integral components of the sample holder then the sample holder can readily be connected and disconnected within an electro-deposition apparatus multiple times without any complex metallization steps required to make an electrical connection each time an electro-deposition process is performed.

The sample holder illustrated in FIGS. 1(a) and 1(b) comprises a single unitary piece of electrically conductive synthetic diamond material. This may be formed, for example, of boron doped CVD synthetic diamond material which may be single crystal or polycrystalline. Alternatively, the sample holder may comprise an electrically insulating synthetic diamond support matrix in which one or more electrically conductive synthetic diamond electrodes are disposed. For example, the sample holder may comprise at least two electrically conductive synthetic diamond electrodes including at least one first electrode located in an area exposed to the x-ray excitation beam when the sample holder is mounted to the XRF sample stage. Furthermore, at least one second electrode may be provided and located outside the area exposed to the x-ray excitation beam when the sample holder is mounted to the XRF sample stage. For example, the at least one second electrode may be in the form of a ring disposed around the at least one first electrode.

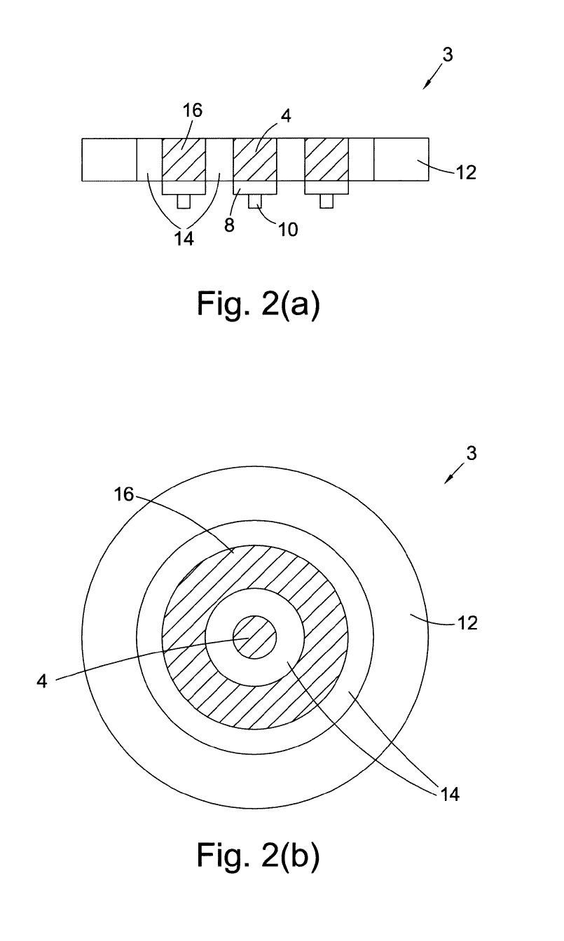

FIGS. 2(a) and 2(b) show side cross-section and front plan view diagrams respectively of such a sample holder 3. As in the configuration shown in FIGS. 1(a) and 1(b), the sample holder comprises: an electrically conductive synthetic diamond electrode 4 providing a front surface on which chemical species can be electro-deposited from a solution comprising the chemical species; an ohmic contact 8 disposed on a rear surface of the electrically conductive synthetic diamond electrode; an electrical contact 10 connected to the ohmic contact; and an electrically insulating mounting 12 around a peripheral region of the sample holder. However, in this case the central diamond electrode 4 is embedded in an electrically insulating synthetic diamond support matrix 14. Furthermore, an additional ring electrode 16 is provided within the electrically insulating synthetic diamond support matrix, the ring electrode 16 disposed around the central electrode 14. The ring electrode is also provided with one or more ohmic contacts and electrical connectors. As will be discussed later, a potential can be applied to the ring electrode in order to electrochemical generate protons or hydroxide ions to change the pH of the solution over the electro-deposition electrode 4 thereby improving the efficiency and/or selectivity of electrochemical processes.

In addition to the above, a variety of electrode structures are envisaged for use with embodiments of the present invention. For example, the electrodes may be formed as one or more macroelectrodes or in the form a microelectrode array. Microelectrode arrays can be advantageous in achieving a more efficient electro-deposition process prior to application of an x-ray fluorescence analysis technique. Furthermore, a plurality of electrodes can be utilized to optimize deposition and stripping conditions, e.g. by electrochemically optimizing pH conditions for deposition and stripping of species of interest. For examples, as previously described with reference to FIGS. 2(a) and 2(b), the sample holder may comprise at least two electrically conductive synthetic diamond electrodes including at least one electrode located in the area x-rays are incident on the surface of the sample holder in use. That electrode is configured to electro-deposit chemical species thereon. The other electrode can then be configured to manipulate solution conditions during the electro-deposition process to thereby increase the efficiency and/or selectivity of the electro-deposition process prior to x-ray fluorescence analysis. That is, the sample holder may include an electro-deposition electrode and a further electrode configured adjacent to the electro-deposition electrode (e.g. in a ring around the electro-deposition electrode) to manipulate solution conditions by, for example, electrochemically varying the pH of the solution in the immediate vicinity of the electro-deposition electrode thereby enhancing electro-deposition of certain species of interest.

The electrically conductive synthetic diamond electrode structures as described above can be fabricated such that they are disposed in a support substrate comprising electrically insulating synthetic diamond material. As such, the electrodes and the support can be fabricated as a unitary piece of synthetic diamond material. While it is considered advantageous to provide an electrode structure fabricated entirely out of diamond material such that electrically conductive diamond electrodes are defined within a non-conductive diamond support matrix, it is also possible to define one or more electrodes by applying an electrically insulating mask (e.g. an electrically insulating polymer) to an electrically conductive diamond material, with one or more windows through the mask defining one or more electrodes (e.g. defining a micro-electrode array).

The sample holder further comprises an ohmic contact to the electrically conductive synthetic diamond material, the ohmic contact configured to be located outside the area x-rays are incident on the surface of the sample holder on an opposite side of the electrically conductive synthetic diamond material to the surface on which chemical species are electro-deposited in use. Even if the ohmic contact is provided on a rear surface of the electrode, if the electrode is relatively thin and transparent to x-rays then it can still be advantageous to pattern the ohmic contact such that it does not lie in a region which may be subjected to x-rays passing through the electrode. Typical ohmic contacts for electrically conductive diamond material may include, for example, titanium and gold which can produce an x-ray fluorescence signal if placed within the x-ray beam path thus contaminating the signal from the sample of interest.

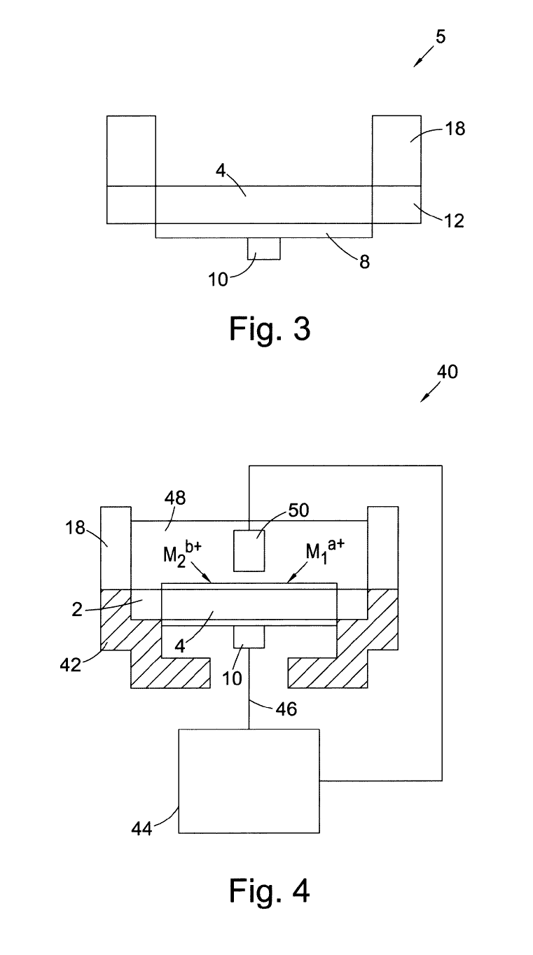

The system may further comprise a solution holder configured to contain and locate a solution on the front surface of the electrically conductive synthetic diamond electrode. For example, the sample holder may comprise the solution holder, the solution holder being mounted on the sample holder to form a container configured to contain and locate the solution on the front surface of the electrically conductive synthetic diamond electrode. FIG. 3 shows such a sample holder configuration. The sample holder 5 is similar to that illustrated in FIGS. 1(a) and 1(b) in that it comprises: an electrically conductive synthetic diamond electrode 4 providing a front surface on which chemical species can be electro-deposited from a solution comprising the chemical species; an ohmic contact 8 disposed on a rear surface of the electrically conductive synthetic diamond electrode; an electrical contact 10 connected to the ohmic contact; and an electrically insulating mounting 12 around a peripheral region of the sample holder. In addition, the sample holder comprises a solution holder 18 which may be in the form of a cup to hold a solution of interest. The solution holder 18 may be detachably mountable to the sampler holder, for example via the electrically insulating mounting 12 or may be integrally formed at part of the electrically insulating mounting 12. A detachable solution holder may be advantageous so that the solution holder can be cleaned or otherwise replaced with a new solution holder to avoid contamination between cycles of use. While the solution holder of the illustrated embodiment is mounted on the electrically insulating mounting 12, the solution holder could be mounted directly on the diamond material of the sample holder (either the electrically conductive diamond material or electrically insulating diamond material which surrounds the electrically conductive diamond material).

FIG. 4 shows an electro-deposition apparatus 40 comprising the sample holder 2 shown in FIGS. 1(a) and 1(b). The electro-deposition apparatus comprises:
an electro-deposition sample stage 42 configured to receive the sample holder 2;
an electrical controller 44 having an electrical connector 46 configured to connect to the electrical connector 10 of the sample holder 2,
wherein the electrical controller 44 is configured to electro-deposit the chemical species M₁^{a+}, M₂^{b+} onto the front surface of the electrically conductive synthetic diamond electrode 4 when the sample holder is mounted to the electro-deposition sample stage 40, electrically connect to the electrical controller 44, and exposed to a solution 48 comprising the chemical species.

In the illustrated arrangement the electro-deposition apparatus comprises a solution holder 18 mounted on the electro-deposition sample stage 44 to form a container configured to contain and locate the solution 48 on the front surface of the electrically conductive synthetic diamond electrode 4 when the sample holder is mounted to the electro-deposition sample stage. This configuration is an alternative to that illustrated in FIG. 3 where the solution holder is mounted to the sample holder. As with the configuration shown in FIG. 3, Again, the solution holder may by detachably mountable for cleaning and/or replacement. Furthermore, while a simple cup-shaped solution holder is illustrated in FIGS. 3 and 4, the solution holder may be in the form of a solution channel which can be connected to a flow system for circulating solution over the electro-deposition electrode. In such a configuration, the electro-deposition apparatus may comprise a solution flow system.

The electro-deposition apparatus shown in FIG. 4 is provided with a reference electrode 50 which is placed in electrical contact with the solution 48. The reference electrode 50 and the diamond electrode 4 in the sample holder are electrically connected to an electrical controller 44. While the illustrated embodiment comprises a separate reference electrode in certain embodiments it is envisaged that the reference electrode can be integrated into the diamond electrode structure, i.e. provided by another electrically conductive diamond electrode in the diamond component of the sample holder. For example, the ring electrode illustrated in FIG. 2 may be used as a reference electrode.

The electrical controller 44 is configured to apply a potential difference between the reference electrode 50 and the electro-deposition electrode 4 in order to electro-deposit chemical species M₁^{a+}, M₂^{b+} from solution. As previously described with reference to the sample holder illustrated in FIGS. 2(a) and 2(b), if a further ring electrode is provided then the electrical controller can also apply a potential to the ring electrode in order to electrochemical generate protons or hydroxide ions to change the pH of the solution over the electro-deposition electrode 18 thereby improving the efficiency of the electro-deposition process.

In order to determine the concentration of a species of interest in a solution a known volume of solution can be completely depleted of the species of interest during the electro-deposition process. A flow cell may be provided such that the solution of interest is circulated past the electrode during electro-deposition. The solution may be re-circulated past the electrode multiple times during the electro-deposition cycle in order to increase the quantity of species electro-deposited onto the electrode and thus increase sensitivity at low concentrations. Alternatively, or additionally, electric current or charge measurements can be used in combination with solution volume measurements and known mass transport equations in order to calibrate the device such that x-ray spectroscopic data from deposited species can be converted into concentrations of species in the solution of interest.

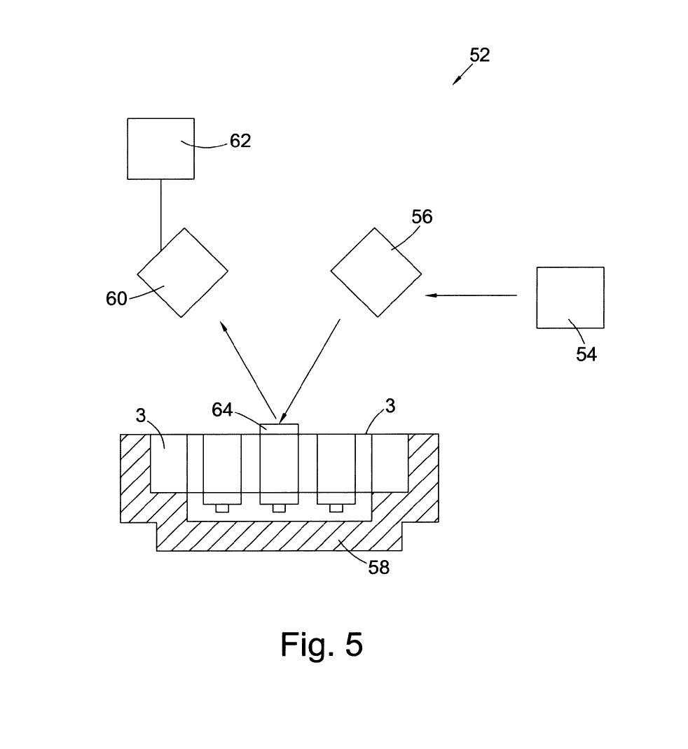

After electro-deposition, the sample holder 2 can be transferred to an x-ray fluorescence spectrometer to perform x-ray fluorescence spectroscopy on the chemical species deposited on the electrode 4. FIG. 5 shows an x-ray fluorescence spectrometer 52 comprising the sample holder 3 shown in FIGS. 2(a) and 2(b). The spectrometer comprises an x-ray source 54, a polarizer 56, an XRF sample stage 58 on which a sample holder 3 is disposed, an x-ray detector 60, and a processor 62. In use, x-rays are directed onto a sample 64 which has previously been electro-deposited on the sample holder 3. X-rays emitted from the sample 64 are detected and processed to generate x-ray fluorescence data.

The XRF sample stage is configured such that the sample holder can be readily mounted and removed therefrom. The XRF sample stage may be of a comparable configuration to that of the electro-deposition stage and complimentary to the shape of the sample holder such that the sample holder can be readily transferred between the XRF apparatus and the electro-deposition apparatus. Furthermore, in use it is important that the sample holder is precisely and reliably positioned relative to the x-ray source and detector. For example, if the sample holder is accidentally mounted at a slight angle then the angle of the electro-deposited layer will be displaced from the optimum orientation required for maximizing detection of the x-rays emitted from the electro-deposited layer to the detector. This can reduce the sensitivity of the device and introduce errors into the spectroscopic measurement, particularly if a total reflectance XRF technique is being utilized. Accordingly, it is advantageous to provide a mounting arrangement which allows precise and re-producible positioning of the sample holder. As an alternative, or in addition, it can be useful to provide an adjustable sample stage such that the position and/or orientation of the sample holder can be adjusted. This may be achieved by measuring the intensity of detected x-rays and adjusting the orientation of the sample stage to maximize detection intensity and minimize interference.

As stated above, certain XRF configurations such as total reflectance XRF are very sensitive to angular variations in the sample holder. Variations in flatness over the region of the sample holder where the x-ray analysis is performed will thus detrimentally affect the analysis as some regions will be disposed at a non-optimal angular orientation thus detrimentally affecting the sensitivity and uniformity of the analysis technique. While variations in sample holder flatness are not so problematic for standard sample holder materials which are readily processed to a flat surface, diamond materials are notoriously difficult to process to a highly flat finish due to the extreme hardness of the diamond material. As such, while processing techniques for obtaining a highly flat diamond surface are known, they are time consuming and relatively expensive and thus are only used when a particular application requires such a highly flat diamond surface. It would appear that the presently described x-ray analysis application may be sufficiently sensitive to surface flatness variations in certain XRF configurations that it falls into this category of application and requires processing of the electrically conductive diamond material to achieve a high surface flatness.

Highly flat electrically conductive synthetic diamond material can be achieved by lapping and polishing techniques known in the art of diamond materials processing. For higher sensitivity, an increasingly flat surface is desirable to reduce signal to noise in the x-ray fluorescence spectroscopic data. As such, according to certain embodiments the flatness variation of the electrically conductive synthetic diamond electrode may be no more than 10 μm, 5 μm, 1 μm, 500 nm, or 100 nm, at least over the area x-rays are incident on the surface of the electrically conductive synthetic diamond electrode in use.

Following on from the above, it has been noted that while coated electrodes which comprises a non-diamond support substrate with a very thin layer of diamond material disposed thereon can be utilized as a sample holder in x-ray fluorescence techniques as described herein, coated electrodes can be problematic as the thin diamond coating is difficult to process into a highly flat configuration without damaging the coating. Furthermore, such coated electrodes are not as robust to cleaning cycles and have a tendency for the coating to delaminate. As such, the present inventors consider that it would be desirable for a diamond based sample stage in x-ray fluorescence applications to be formed of an electrically conductive synthetic diamond material of sufficient thickness that it can readily be processed to a flat surface finish as well as being robust to multiple electro-deposition and cleaning cycles such that the electrode can be re-used many times. The electrically conductive synthetic diamond material may be fabricated as a free-standing plate. An additional advantage of providing a thicker layer of electrically conductive synthetic diamond material in a front-face x-ray analysis technique is that this will alleviate problems of incident x-rays passing though the electrode and impinging on components behind the electrode which may produce an x-ray fluorescence signal thus contaminating the signal from the material being analysed. As previously indicated, since embodiments of the present invention are particularly concerned with increasing the sensitivity of x-ray fluorescence analysis techniques for chemical species present at low concentration then any low intensity contaminant signal decreasing the signal to noise ratio can be particularly problematic.

In light of the above, the electrically conductive synthetic diamond electrode may have a thickness no less than 50 μm, 70 μm, 90 μm, 110 μm, 150 μm, 200 μm, or 250 μm. However, increasing the thickness of the electrically conductive synthetic diamond material increases the cost of synthesis. Furthermore, while there are benefits to fabricating the electrically conductive synthetic diamond material to a certain thickness as described above, beyond a certain thickness at which these advantageous features are provided there is little benefit in moving to increasingly thick layers. As such, the electrically conductive synthetic diamond electrode may have a thickness no greater than 500 μm, 400 μm, or 350 μm. For example, the electrically conductive synthetic diamond electrode may have a thickness in a range 50 μm to 500 μm, 100 μm to 400 μm, or 200 μm to 350 μm.

In addition to surface flatness and electrode thickness, the signal to noise ratio of the x-ray fluorescent spectrometer may also be affected by the surface roughness of the electrically conductive synthetic diamond material. As with surface flatness, it should be noted that processing diamond material to have a low surface roughness is notoriously difficult due to the extreme hardness of the diamond material. As such, while processing techniques for obtaining a low roughness diamond surface are known, they are time consuming and relatively expensive and thus are only used when a particular application requires such a low roughness diamond surface. It would appear that the presently described x-ray analysis application may be sufficiently sensitive to surface roughness in certain XRF configurations that it falls into this category of application and requires processing of the electrically conductive diamond material to achieve a low surface roughness. The surface of the electrically conductive synthetic diamond electrode may have a surface roughness Rₐ of no more than 50 nm, 30 nm, 15 nm, 10 nm, or 5 nm, at least over an area where the x-ray excitation beam is incident on the front surface of the electrically conductive synthetic diamond electrode when the sample holder is mounted to the XRF sample stage. Methods for achieving low roughness diamond surfaces include polishing and etching techniques such as chlorine-argon plasma etching.

It may be noted that flatness and roughness are two distinct parameters. Surface roughness Ra is the measurement of microscopic variations in the height of a surface relative to a mean line. In contrast, flatness is the measurement of macroscopic variation of the mean surface line from a perfect flat plane. As such, a smooth surface can have very low roughness but still have very poor flatness if the smooth surface is curved. Similarly, a relatively rough surface can still have a high degree of flatness if the mean surface line does not deviate much from a perfect plane. The surface of the electrically conductive synthetic diamond electrode according to certain embodiments of the present invention has both a low surface roughness and a high degree of flatness, at least over an area where the x-ray excitation beam is incident on the front surface of the electrically conductive synthetic diamond electrode when the sample holder is mounted to the XRF sample stage.

After performing XRF spectroscopy, the sample holder can be removed from the spectrometer for cleaning and re-use. This may be achieved by removal and acid cleaning of the sample holder. Alternatively, the electrode may be cleaned by using the electro-deposition apparatus to electrically strip species from the surface of the sample holder. For example, the sample holder can be transferred back into an electro-deposition apparatus such as that illustrated in FIG. 4. The electrical controller 44 can then be used to apply a potential difference between the reference electrode 50 and the electro-deposition electrode 4 in order to electrically strip chemical species on the diamond electrode back into solution. A potential can also be applied to a ring electrode if present in order to electrochemical generate protons or hydroxide ions to change the pH of the solution over the electro-deposition electrode thereby improving the efficiency of the stripping process and/or change the selectivity of the electrochemical stripping.

Optionally, the current flow or charge can be measured during electro-chemical stripping to generate stripping voltammetry data which can be used in combination with the x-ray fluorescence date to given information about the type and quantity of species in the solution.

In certain arrangements the spectroscopic data alone is used to measure the type and, optionally, quantity of chemical species. Alternatively, electric current can be measured during stripping of the electro-deposited chemical species thereby generating voltammetry data for the electro-deposited chemical species. In such arrangements, the electro-deposition electrode is functioning as an electrochemical sensing electrode and a second electrode functions as a reference electrode in an electrochemical sensor configuration. Both the spectroscopic data and the voltammetry data may then be used to determine the type and quantity of chemical species in the solution. For example, the spectroscopic data may be used to determine the type of chemical species deposited on the sensing electrode and the voltammetry data can be used to determine the quantity of chemical species deposited on the sensing electrode. In such arrangements, the spectroscopic data can be used to improve discrimination between electrochemical species and aid in resolving and assigning peaks in the voltammetry data. Alternatively, controlled electrochemical deposition can be utilized to selectively deposit chemical species and thus separate x-ray peaks which would otherwise overlap. Accordingly, a sensing method can be provided which is suitable for monitoring low concentrations of a plurality of chemical species in complex chemical environments.

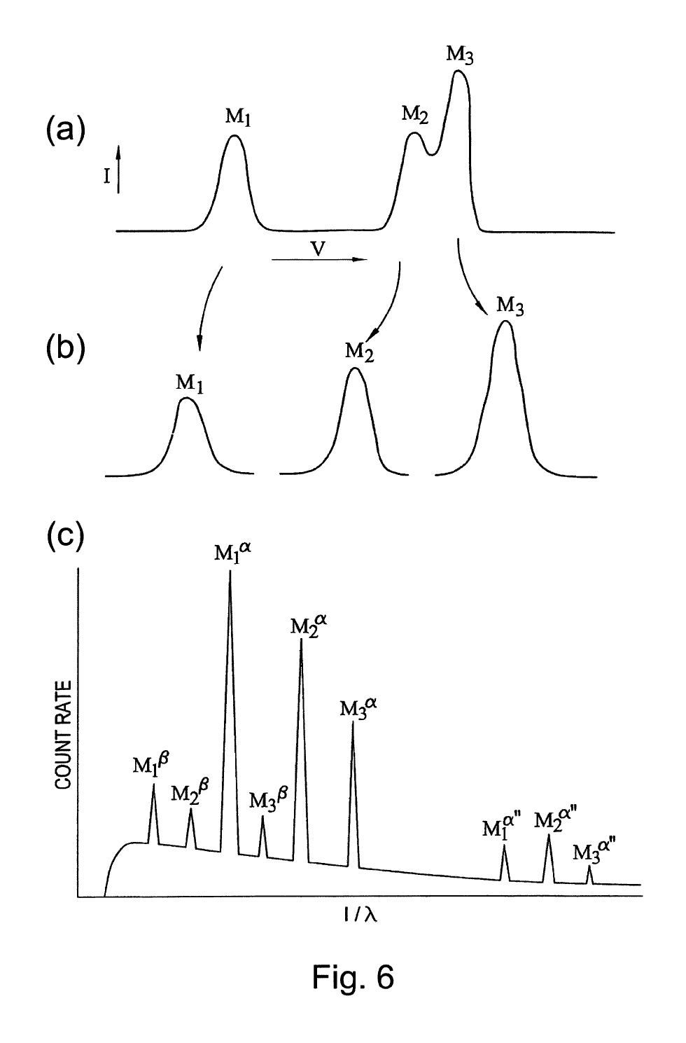

FIGS. 6(a) to 6(c) illustrate an example of data generated using the aforementioned method. FIG. 6(a) shows a stripping voltammogram generated by an apparatus such as that illustrated in FIG. 4. The stripping voltammogram comprises oxidation peaks for three species M₁, M₂, and M₃. Although there is some overlap between the peaks, they are sufficiently separated that the stripping voltammogram can be deconvoluted into three separate voltammograms, one for each species as illustrated in FIG. 6(b). These voltammograms can be used to identify the type and quantity of each species by peak location and area measurements. In practice, this can be done numerically or by generating pictorial representations of the voltammetry data. For example, the composite voltammogram can be deconvoluted using Fourier analysis techniques. Peak locations can be compared to a reference potential to identify different target species of interest. The peaks can be numerically integrated in order to determine quantitative information about the individual species. These techniques are known to those skilled in the art.

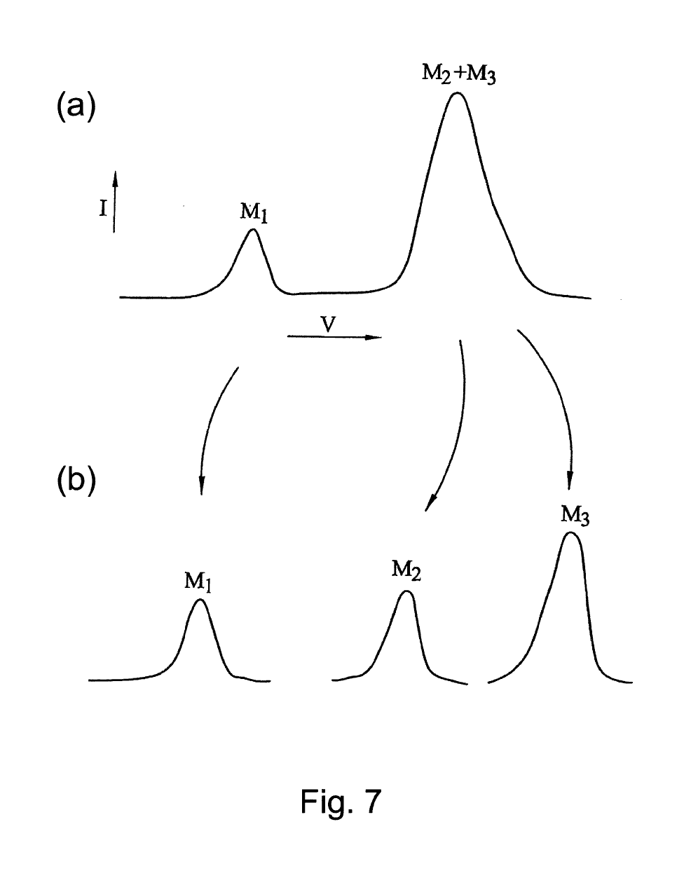

In addition to the voltammetry data discussed above, FIG. 6(c) illustrates an x-ray fluorescence spectrum generated by an apparatus such as that illustrated in FIG. 5. The spectrum K_{α}, K_{β}, and second order K_{α}″ lines for the three metal species previously discussed. This spectroscopic information can also be used to determine the type and quantity of species electro-deposited on the diamond electrode. In the event that the target species are individually identifiable and quantifiable in the stripping voltammetry data, this spectroscopic data may be somewhat superfluous and may merely serve to confirm results obtain via stripping voltammetry. However, in the case that one or more of the target species have overlapping peak in the stripping voltammetry data such that the data cannot be readily be deconvoluted, the spectroscopic data can either be used as a means to deconvolute the voltammetry data or otherwise used instead of the voltammetry data to identify and quantify individual target species. For example, FIG. 7(a) shows a stripping voltammogram for three target species M₁, M₂, and M₃ where the peaks for species M₂ and M₃ completely overlap. Decovolution of this voltammogram without any other information may result in the erroneous identification of only two species, e.g. M₁ and M₂ only or M₁ and M₃ only, or otherwise give an ambiguous result indicating that M₂ and/or M₃ may be present. In this case, spectroscopic data as indicated in FIG. 6(c) can be used to correctly deconvolute the composite voltammogram illustrated in FIG. 7(a) into its three constituent parts as shown in FIG. 7(b). Alternatively, the spectroscopic data could be used on its own, the electrical controller merely being utilized as a means of depositing species for spectroscopic analysis. However, in practice the voltammetry data and the spectroscopic data can provide complimentary information. For example, the spectroscopic data can give elemental information which may not be resolved in the voltammetry data whereas the voltammetry data may give information relating to the oxidative state of species within the solution which cannot be identified from the spectroscopic data. The voltammetry data will also be more sensitive to species present at low concentration.

If the system is to utilize data from both the electro-deposition apparatus and the XRF spectrometer then the system must comprise a means for collecting and interpreting data from both pieces of apparatus. As such, the system may further comprise a processor configured to receive x-ray fluorescence spectroscopic data from the x-ray fluorescence spectrometer, voltammetry data from the electro-deposition apparatus, and further configured to process both the x-ray fluorescence spectroscopic data and the voltammetry data to determine the type and quantity of chemical species in the solution. This functionality may be provided a computer suitable programmed to receive and interpret data from both the electro-deposition apparatus and the XRF spectrometer.

As previously discussed, the use of a diamond electrode material in combination with an x-ray spectroscopic analysis technique is considered to be particularly preferable for implementing the present invention. Embodiments of the invention will increase functionality and performance in terms of resolution and sensitivity for analysing solutions which contain a plurality of different target species of interest. Previously, for solutions which comprise a number of different species having overlapping voltammetry peaks, for example a number of heavy metal species having similar electrochemical potentials, it may only have been possible to determine the total species content, e.g. the total heavy metal content. In contrast, embodiments of the present invention allow identification and quantification of a large range of different species in a single solution even when voltammetry peaks overlap.

Embodiments of the present invention may have several advantageous features including one or more of the following:
(1) Improved spectroscopic sensitivity by concentrating species using electro-deposition;
(2) Improved species discrimination in a multi-species solution by making comparative spectroscopic and electrochemical measurements; and
(3) Reduced spectroscopic interference from the sample holder.

Other useful techniques may be combined with the electrochemical/spectroscopic techniques described herein. For example, differential potential pulse programmes can be used in the electro-deposition apparatus to increase sensitivity. Furthermore, the temperature of the electro-deposition electrode can be changed to alter mass transport, reaction kinetics, and alloy formation. For example, heating during stripping voltammetry can aid in increasing peak signals. Heating during deposition can aid formation of better alloys and can also increase mass transport, shortening deposition times and/or increasing deposition to within the detection sensitivity of spectroscopic techniques such as XRF. Accordingly, in certain arrangements configured to detect very low concentrations of chemical species in solution a heater may be provided within the sample holder or electro-deposition apparatus for heating the electro-deposition electrode to increase deposition to within the limits of the spectroscopic analysis technique. The use of diamond material for the electro-deposition electrode is also useful in this regard as diamond material can be heated and cooled very quickly. The high electrode potential of diamond material and the stability of diamond material when applying high potentials can also be utilized to alter pH via electrochemical generation. For metal ions which are complexed in solution, digests are normally performed to free them so they are available for subsequent reduction. One way to do this is to generate very strong acid (or base) conditions electrochemically. Furthermore, certain chemical species can be electro-deposited and/or stripped in a more well defined manner under certain pH conditions.

Generating very strong acid (or base) conditions electrochemically, or other species such as ozone or hydrogen peroxide, is also useful for cleaning the electrode. Other cleaning techniques may involve abrasive cleaning and/or heating. Again, use of a diamond material is advantageous in this regard as the diamond material is robust to abrasive, chemical, and/or heat treatments for cleaning and thus a good sensing surface can be re-generated between analysis cycles. In order to ensure that the sensing electrode is clean after a sensing cycle and prior to initiation of a further cycle an additional spectroscopic analysis and/or an electro-stripping cycle may be applied to determine if the sensing electrode is clean. For example, residual chemical species adhered to the electrode may be evident in voltammetry and/or spectroscopic data generated during such a cleanliness checking step. If so, a cleaning cycle can be performed. A further spectroscopic analysis and/or an electro-stripping cycle may than be applied to confirm that the sensing electrode is sufficiently clean for further use. As such, cleaning and checking of electrode surfaces can be performed.

Embodiments of the present invention allow detection and quantification of a large range of chemical species in complex solution environments at low concentration levels including, for example, calcium (“scaling capacity”), copper, zinc, cadmium, mercury, lead, arsenic, aluminium, antinomy, iodine, sulphur, selenium, tellurium, and uranium, etc. Furthermore, the electrically conductive diamond sample holders according to embodiments of the present invention are robust to harsh chemical and thermal environments and can readily be cleaned and re-used many times without the need for replacement.

While this invention has been particularly shown and described with reference to preferred embodiments, it will be understood to those skilled in the art that various changes in form and detail may be made without departing from the scope of the invention as defined by the appendant claims.

1. A system comprising:
an x-ray fluorescence spectrometer; and
a sample holder for the x-ray fluorescence (XRF) spectrometer, wherein the sample holder comprises:
an electrically conductive synthetic diamond electrode providing a front surface on which chemical species can be electro-deposited from a solution comprising the chemical species;
an ohmic contact disposed on a rear surface of the electrically conductive synthetic diamond electrode; and
an electrical connector which is connected to the ohmic contact, and wherein the x-ray fluorescence spectrometer comprises:
an XRF sample stage configured to receive the sample holder;
an x-ray source configured to apply an x-ray excitation beam to the chemical species electro-deposited on the electrically conductive synthetic diamond electrode when the sample holder is mounted to the XRF sample stage;
an x-ray detector configured to receive x-rays emitted from the chemical species electro-deposited on the front surface of the electrically conductive synthetic diamond material when the sample holder is mounted to the XRF sample stage; and
a processor configured to generate x-ray fluorescence spectroscopic data based on the x-rays received by the x-ray detector.

2. A system according to claim 1, further comprising an electro-deposition apparatus, the electro-deposition apparatus comprising:
an electro-deposition sample stage configured to receive the sample holder;
an electrical controller having an electrical connector configured to connect to the electrical connector of the sample holder,
wherein the electrical controller is configured to electro-deposit the chemical species onto the front surface of the electrically conductive synthetic diamond electrode when the sample holder is mounted to the electro-deposition sample stage, electrically connected to the electrical controller, and exposed to the solution comprising the chemical species.

3. A system according to claim 2, wherein the electrical controller is further configured to strip the electro-deposited chemical species from the electrically conductive synthetic diamond electrode.

4. A system according to claim 3, wherein the electrical controller is configured to measure an electric current or charge during stripping of the electro-deposited chemical species thereby generating voltammetry data for the electro-deposited chemical species.

5. A system according to claim 4, further comprising a processor configured to receive x-ray fluorescence spectroscopic data from the x-ray fluorescence spectrometer, voltammetry data from the electro-deposition apparatus, and further configured to process both the x-ray fluorescence spectroscopic data and the voltammetry data to determine the type and quantity of chemical species in the solution.

6. A system according to claim 1, further comprising a solution holder configured to contain and locate the solution on the front surface of the electrically conductive synthetic diamond electrode.

7. A system according to claim 6, wherein the sample holder comprises the solution holder, the solution holder being mounted on the sample holder to form a container configured to contain and locate the solution on the front surface of the electrically conductive synthetic diamond electrode.

8. A system according to claim 6, wherein the electro-deposition apparatus comprises the solution holder, the solution holder being mounted on the electro-deposition sample stage to form a container configured to contain and locate the solution on the front surface of the electrically conductive synthetic diamond electrode when the sample holder is mounted to the electro-deposition sample stage

9. A system according to claim 7, wherein the solution holder is detachably mountable to the sample holder or the electro-deposition sample stage.

10. A system according to claim 1, wherein the sample holder comprises an electrically insulating synthetic diamond support matrix in which the electrically conductive synthetic diamond electrode is disposed.

11. A system according to claim 1, wherein the sample holder comprises at least two electrically conductive synthetic diamond electrodes including at least one first electrode located in an area exposed to the x-ray excitation beam when the sample holder is mounted to the XRF sample stage.

12. A system according to claim 11, wherein the at least two electrically conductive synthetic diamond electrodes includes at least one second electrode located outside the area exposed to the x-ray excitation beam when the sample holder is mounted to the XRF sample stage.

13. A system according to claim 12, wherein the at least one second electrode is in the form of a ring disposed around the at least one first electrode.

14-16. (canceled)

17. A system according to claim 1, wherein the front surface of the electrically conductive synthetic diamond electrode has a flatness variation of no more than 10 μm, 5 μm, 1 μm, 500 nm, or 100 nm, at least over an area where the x-ray excitation beam is incident on the front surface of the electrically conductive synthetic diamond electrode when the sample holder is mounted to the XRF sample stage.

18. A system according to claim 1, wherein the front surface of the electrically conductive synthetic diamond electrode has a surface roughness Rₐ of no more than 50 nm, 30 nm, 15 nm, 10 nm, or 5 nm, at least over an area where the x-ray excitation beam is incident on the front surface of the electrically conductive synthetic diamond electrode when the sample holder is mounted to the XRF sample stage.

19-23. (canceled)
